(19) United States
(12) Patent Application Publication
(10) Pub. No.: US 2012/0189866 A1
(43) Pub. Date: Jul. 26, 2012

(54) COMPOSITE SUBSTRATE

(75) Inventors: Jinn Chu, Keelung City (TW); Bo-Shian Houng, Yunlin County (TW)

(73) Assignee: National Taiwan University of Science and Technology, Taipei (TW)

(21) Appl. No.: 13/111,975

(22) Filed: May 20, 2011

(30) Foreign Application Priority Data
Jan. 20, 2011 (TW) 100102046

(51) Int. Cl. B32B 15/00

(52) U.S. Cl. 428/615

(57) ABSTRACT

A composite substrate including an amorphous metallic substrate and a metallic glass layer is provided. The metallic glass layer is deposited on the amorphous metallic substrate. The composite substrate adopts the metallic glass layer for the amorphous metallic substrate to have ductility and improving a problem of room-temperature brittleness of the amorphous metallic substrate so as to raise the application value of the amorphous metallic substrate.

### CROSS-REFERENCE TO RELATED APPLICATION

This application claims the priority benefit of Taiwan application serial no. 100102046, filed Jan. 20, 2011. The entirety of the above-mentioned patent application is hereby incorporated by reference herein and made a part of this specification.

### BACKGROUND OF THE INVENTION

1. Field of the Invention

The invention is related to a composite substrate and more particularly to a composite substrate disposed with a metallic glass layer.

2. Description of Related Art

Studies in bulk metallic glass (BMG) have become popular in recent years mainly due to the unique mechanical, physical, and chemical properties of BMG. The greatest difference between a BMG and an alloy is that a BMG is an amorphous structure, so that the BMG has characteristics such as high rigidity, high wear resistance, and brittleness. However, the application of a mechanical structural material requires a material with high strength, high wear resistance, high toughness, and ductility. The application of a BMG is thus severely limited. Therefore, one of the most important issues now is to enhance the ductility of the BMG.

Herein, ductility is a significant mechanical property of a structural material. For a crystalline material, since a dislocation structure thereof is easy to move in a sliding system, the crystallization material therefore has ductility. The amorphous material can be, for example, a BMG, as atoms thereof are arranged irregularly, a dislocation structure is absent in the irregular atomic structure and can not move in a sliding system, so that the BMG does not have ductility. Since the atoms are arranged irregularly in the BMG, the free volume between atoms is larger than the crystalline material. When the BMG is under the effect of shear stress, inner atoms thereof are affected by the shear stress so as to form a small group of tightly stacked atomic clusters called shear bands. Current studies show that the BMG is capable of undergoing plastic deformation and has ductility because of these shear bands. Researches regarding the enhancement of ductility of the BMG are mainly categorized into changing the structure of the BMG and modifying the surface of the BMG.

### SUMMARY OF THE INVENTION

The invention is directed to a composite substrate capable of solving the lack of ductility of an amorphous metallic substrate so as to widen the application of the amorphous metallic substrate in structural material.

The invention is directed to a composite substrate including an amorphous metallic substrate and a metallic glass layer. The metallic glass layer is disposed on the amorphous metallic substrate.

In one embodiment of the invention, a thickness of the metallic glass layer ranges from 50 nanometer (nm) to 1000 nm.

In one embodiment of the invention, the metallic glass layer is selected from a group consisting of a Zr-based metallic glass, a Mg-based metallic glass, a La-based metallic glass, a Pd-based metallic glass, and a Cu-based metallic glass.

In one embodiment of the invention, a material of the amorphous metallic substrate includes a metallic glass.

In one embodiment of the invention, the amorphous metallic substrate is selected from a group consisting of a Zr-based metallic glass, a Mg-based metallic glass, a La-based metallic glass, a Pd-based metallic glass, and a Cu-based metallic glass.

In one embodiment of the invention, the composite substrate of the invention further includes an adhesive layer disposed between the amorphous metallic substrate and the metallic glass layer.

In one embodiment of the invention, a material of the adhesive layer is a titanium metal or a chromium metal.

In one embodiment of the invention, the metallic glass layer is formed on the amorphous metallic substrate using a magnetron sputtering method.

In one embodiment of the invention, the amorphous metallic substrate is formed using a casting process.

In light of the foregoing, the composite substrate of the invention adopts the metallic glass layer for the amorphous metallic substrate to obtain ductility under room temperature. As a consequence, the brittleness of the amorphous metallic substrate under room temperature is improved and the application value of the amorphous metallic substrate is increased.

In order to make the aforementioned and other features and advantages of the invention more comprehensible, several embodiments accompanied with figures are described in detail below.

### BRIEF DESCRIPTION OF THE DRAWINGS

The accompanying drawings are included to provide further understanding, and are incorporated in and constitute a part of this specification. The drawings illustrate embodiments and, together with the description, serve to explain the principles of the invention.

FIG. 1 is a schematic cross-sectional diagram showing a composite substrate according to an embodiment of the invention.

FIG. 2 is a diagram showing a relationship between bending stress and bending surface strain of an exemplary embodiment and a comparative embodiment of the invention.

FIG. 3a illustrates the surface of a bulk metallic glass(BMG) observed under a scanning electron microscope(SEM) after a bending test.

FIG. 3b illustrates the surface of a metallic glass/bulk metallic glass(MG/BMG) observed under an SEM after a bending test.

FIG. 3c illustrates the surface of a metallic glass/titanium/bulk metallic glass(MG/Ti/BMG) observed under an SEM after a bending test.

### DESCRIPTION OF EMBODIMENTS

The invention adopts the characteristics of high toughness and high strength of metallic glass thin films (MGTFs) and applies MGTFs in the modification of the surface of an amorphous metallic substrate having brittleness. Accordingly, large, individual shear bands are prevented from forming on the surface of the amorphous metallic substrate, such that the plastic strain of the amorphous metallic substrate is enhanced in room temperature.

A metallic glass layer of the invention is an amorphous structure including a small portion of nano-crystalline structure or a metallic glass having an amorphous structure.

The metallic glass layer of the invention is, for example, a Zr-based metallic glass. The Zr-based metallic glass, for instance, is a metallic glass containing Zr and at least two elements selected from a group consisting of Cu, Al, Ni, Ti, Be, Nd, Y, P, Si, Mg, Pd, and La. Herein, Zr accounts for 40 atomic ratio (at. %) to 60 atomic ratio (at. %) of the entire composition. A chemical formula of the composition of the metallic glass layer in the invention is ZrM_{y1}, for example, where M_{y1} is at least two elements selected from a group consisting of Cu, Al, Ni, Ti, Be, Nd, Y, P, Si, Mg, Pd, and La. The metallic glass layer of the invention is, for instance, Zr₅₃Cu₂₉Al₁₂Ni₆, Zr₆₆Al₈Cu₇Ni₁₉, Zr₆₆Al₈Cu₁₂Ni₁₄, Zr₅₇Ti₅Al₁₀Cu₂₀Ni₈ or Zr₄₄Ti₁₁Cu₁₀Ni₁₀Be₂₅.

In addition, the metallic glass layer of the invention can also be, for example, a Mg-based metallic glass. The Mg-based metallic glass, for instance, is a metallic glass containing Mg and at least two elements selected from a group consisting Cu, Al, Ni, Ti, Be, Nd, Y, P, Si, Zr, Pd, and La. Herein, Mg accounts for 60 at. % to 85 at. % of the entire composition. A chemical formula of the composition of the metallic glass layer in the invention is MgM_{y2}, for example, where M_{y2} is at least two elements selected from a group consisting of Cu, Al, Ni, Ti, Be, Nd, Y, P, Si, Zr, Pd, and La. The metallic glass layer of the invention is, for instance, Mg₈₀Ni₁₀Nd₁₀, Mg₇₀Ni₁₅Nd₁₅ or Mg₆₅Cu₂₅Y₁₀.

Moreover, the metallic glass layer of the invention can also be, for example, a La-based metallic glass. The La-based metallic glass, for instance, is a metallic glass containing La and at least two elements selected from a group consisting of Cu, Al, Ni, Ti, Be, Nd, Y, P, Si, Zr, Pd, and Mg. Herein, La accounts for 50 at. % to 60 at. % of the entire composition. A chemical formula of the composition of the metallic glass layer in the invention is LaM_{y3}, for example, where M_{y3} is at least two elements selected from a group consisting of Cu, Al, Ni, Ti, Be, Nd, Y, P, Si, Zr, Pd, and Mg. The metallic glass layer of the invention is, for instance, La₅₅Al₂₅Ni₁₅Cu₅, La₅₅Al₂₅Ni₁₀Cu₁₀ or La₅₅Al₂₅Ni₅Cu₁₅.

Moreover, the metallic glass layer of the invention can also be, for example, a Pd-based metallic glass. The Pd-based metallic glass, for instance, is a metallic glass containing Pd and at least two elements selected from a group consisting of Cu, Al, Ni, Ti, Be, Nd, Y, P, Si, Zr, La, and Mg. Herein, Pd accounts for 40 at. % to 80 at. % of the entire composition. A chemical formula of the composition of the metallic glass layer in the invention is PdM_{y4}, for example, where M_{y4} is at least two elements selected from a group consisting of Cu, Al, Ni, Ti, Be, Nd, Y, P, Si, Zr, La, and Mg. The metallic glass layer of the invention is, for instance, Pd₄₀Cu₃₀Ni₁₀P₂₀, Pd₇₇Cu₆Si₁₇ Or Pd₄₀Ni₄₀P₂₀.

Moreover, the metallic glass layer of the invention can also be, for example, a Cu-based metallic glass. The Cu-based metallic glass, for instance, is a metallic glass containing Cu and at least two elements selected from a group consisting of Al, Ni, Ti, Be, Nd, Y, P, Si, Zr, La, Pd and Mg. Herein, Cu accounts for 50 at. % to 65 at. % of the entire composition. A chemical formula of the composition of the metallic glass layer in the invention is CuM_{y5}, for example, where M_{y5} is at least two elements selected from a group consisting of Al, Ni, Ti, Be, Nd, Y, P, Si, Zr, La, Pd, and Mg. The metallic glass layer of the invention is, for instance, Cu₆₀Zr₃₀Ti₁₀ or Cu₅₄Zr₂₇Ti₉Be₁₀.

However, the composition of the metallic glass layer in the invention is not limited to the embodiments listed above. In other embodiments, the composition of the metallic glass layer in the invention includes any element that can be used for forming the metallic glass. A composition ratio of an embodiment of the metallic glass layer is mainly determined by the formation of glass. Any metallic glass containing the elements aforementioned and having superior metallic glass formation can be adopted as the metallic glass layer of the composite substrate of the invention.

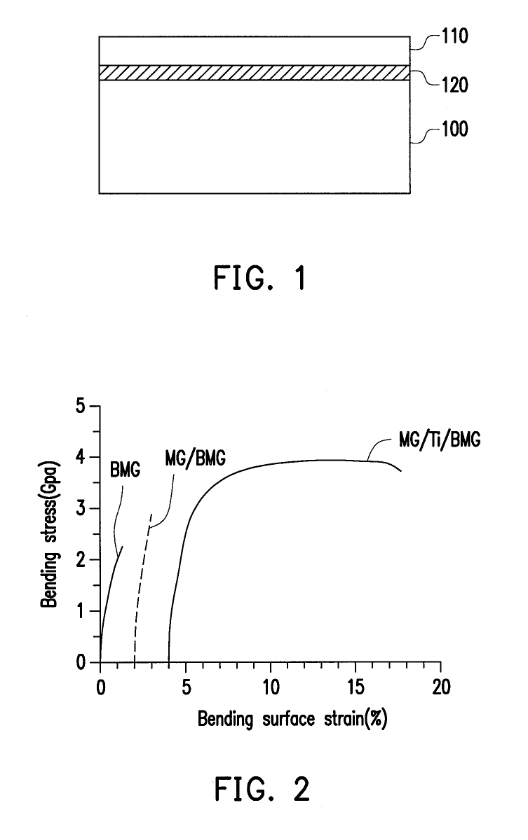

Next, a composite substrate of the invention is illustrated. FIG. 1 is a schematic cross-sectional diagram showing a composite substrate according to an embodiment of the invention.

Referring to FIG. 1, a composite substrate of the invention includes an amorphous metallic substrate 100 and a metal glass layer 110. The metallic glass layer 110 is disposed on the amorphous metallic substrate 100. In one embodiment, a composite substrate of the invention further includes an adhesive layer 120. The adhesive layer 120 is disposed between the amorphous metallic substrate 100 and the metallic glass layer 110.

The amorphous metallic substrate 100 is, for example, an amorphous bulk material. The amorphous metallic substrate 100 can be fabricated using the same material as that utilized for fabricating the metallic glass layer. The amorphous metallic substrate 100 is a commercial bulk metallic glass or a bulk metallic glass formed with a casting process.

The metallic glass layer 110 is a metallic glass layer formed using a magnetron sputtering method, for example. The metallic glass layer 110 has a thickness ranging from 50 nanometer (nm) to 1000 nm.

The adhesive layer 120 is fabricated using, for instance, a titanium metal or a chromium metal. The adhesive layer 120 has a thickness of 10 nm, for example.

The performance of the composite substrate of the invention is illustrated in the following embodiments.

### Embodiment 1 (Represented with MG/BMG Below)

Here, Zr₅₃Cu₂₉Al₁₂Ni₆ is selected as the metal glass layer of an embodiment 1 in the invention, where Zr₅₃Cu₂₉Al₁₂Ni₆ is formed on the amorphous metallic substrate using a magnetron sputtering method. Herein, Zr₅₃Cu₂₉Al₁₂Ni₆ has a thickness of 200 nm. The amorphous metallic substrate is selected from a commercial bulk metallic glass or a bulk metallic glass formed with a casting process.

### Embodiment 2 (Represented with MG/Ti/BMG Below)

A titanium metal is selected as an adhesive layer in an embodiment 2 of the invention. Thereafter, Zr₅₃Cu₂₉Al₁₂Ni₆ is selected as a metal glass layer in the embodiment 2 of the invention. Firstly, the titanium metal is formed on an amorphous metallic substrate using a magnetron sputtering method. The titanium metal has a thickness of 10 nm. Afterwards, Zr₅₃Cu₂₉Al₁₂Ni₆ is formed on the titanium metal layer using the magnetron sputtering method. Herein, Zr₅₃Cu₂₉A₁₂Ni₆ has a thickness of 200 nm. The amorphous metallic substrate is selected from a commercial bulk metallic glass or a bulk metallic glass formed with a casting process.

The fabrication parameter of the magnetron sputtering method is shown as follows: a working pressure is 10 mTorr, a working gas is argon gas, a flow rate is 20 sccm, a working distance is 100 mm (a distance between a target material and a substrate), a depostion time for depositing a 200 nm Zr-based metallic glass thin film is 1,005 seconds and a deposition time for depositing a 10 nm Ti adhesive layer is 65 seconds.

### Comparative Embodiment (Represented with BMG Below)

A commercial bulk metallic glass or a bulk metallic glass formed with a casting process is selected.

In the following, a comparison of characteristics including bending strength, shear band density, toughness, and surface strain in the embodiments and the comparative embodiment of the invention is shown. In the embodiment 1, the embodiment 2, and the comparative embodiment, the amorphous metallic substrate are all fabricated with the same material.

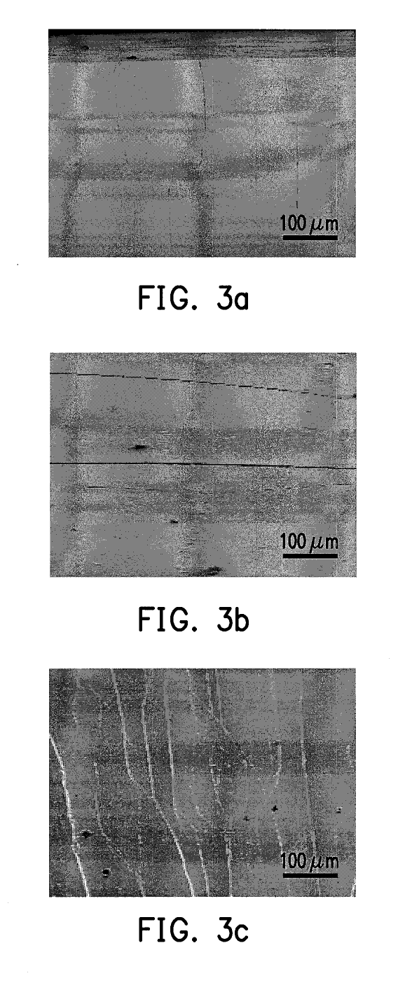

Table 1 is a comparison table showing bending strength, shear band density, toughness, and surface strain in the embodiments and the comparative embodiment of the invention. FIG. 2 is a diagram showing a relationship between bending stress and bending surface strain of the embodiments and the comparative embodiment of the invention. FIG. 3a illustrates the surface of a bulk metallic glass (BMG) observed under a scanning electron microscope (SEM) after a bending test. FIG. 3b illustrates the surface of a metallic glass/bulk metallic glass (MG/BMG) observed under an SEM after a bending test. FIG. 3c illustrates a surface of a metallic glass/titanium/bulk metallic glass (MG/Ti/BMG) observed under an SEM after a bending test.

TABLE 1

| | BMG | MG/BMG | MG/Ti/BMG |
|---|---|---|---|
| Bending strength | 2.2 | 2.9 | 3.7 |
| (GPa) | | | |
| Shear band density | ~3 | ~11 | ~57 |
| (number/mm²) | | | |
| Toughness | 1,945 ± 19 | 2,886 ± 288 | 50,902 ± 5,090 |
| (Joule/m³) | | | |
| Surface strain (%) | ~0% | ~1% | ~14% |

Referring to Table 1 and FIG. 2, a bending test is performed using a four point bending test. A bending strength of MG/BMG is larger than that of BMG, and a bending strength of MG/Ti/BMG is even larger than that of MG/BMG. This depicts that the bending strength characteristic of the embodiments in the invention is better than that of the comparative embodiment.

Referring to Table 1 and FIGS. 3a to 3c, a calculation of shear band density is calculated from the surface observed under the SEM and represents the number of shear bands in one unit area. The number of shear band density determines the ductility of the material. The material undergoes plastic deformation easily and has higher ductility as the shear band density becomes higher. As depicted in FIGS. 3a to 3c, the shear band density of MG/BMG is higher than that of BMG. Moreover, the shear band density of MG/Ti/BMG is higher than that of MG/BMG. This depicts that the ductility of the embodiments in the invention is better than that of the comparative embodiment.

Referring to Table 1 and FIG. 2, the measurement of the toughness of a material is determined with an area circled by a stress vs strain curve corresponding to a strain axis. Therefore, it is shown in FIG. 2 that the toughness of MG/BMG is higher than that of BMG, and the toughness of MG/Ti/BMG is higher than that of MG/BMG. This depicts that the toughness of the embodiments in the invention is better than that of the comparative embodiment.

Referring to Table 1 and FIG. 2, the surface strain is the result obtained after measuring a sample underwent the bending test. In the results measured, the surface strain of MG/BMG is higher than that of BMG, and the surface strain of MG/Ti/BMG is even higher than that of MG/BMG. This depicts that the surface strain of the embodiments in the invention is better than that of the comparative embodiment.

In summary, the composite substrate of the invention adopts the metallic glass layer for the amorphous metallic substrate to obtain ductility. As a consequence, the brittleness of the amorphous metallic substrate is improved and the application value of the amorphous metallic substrate is increased.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A composite substrate, comprising:
an amorphous metallic substrate; and
a metallic glass layer disposed on the amorphous metallic substrate.

2. The composite substrate as claimed in claim 1, wherein a thickness of the metallic glass layer ranges from 50 nanometer (nm) to 1,000 nm.

3. The composite substrate as claimed in claim 1, wherein the metallic glass layer is selected from a group consisting of a Zr-based metallic glass, a Mg-based metallic glass, a La-based metallic glass, a Pd-based metallic glass, and a Cu-based metallic glass.

4. The composite substrate as claimed in claim 1, wherein a material of the amorphous metallic substrate comprises a metallic glass.

5. The composite substrate as claimed in claim 4, wherein the amorphous metallic substrate is selected from a group consisting of a Zr-based metallic glass, a Mg-based metallic glass, a La-based metallic glass, a Pd-based metallic glass, and a Cu-based metallic glass.

6. The composite substrate as claimed in claim 1, further comprising an adhesive layer disposed between the amorphous metallic substrate and the metallic glass layer.

7. The composite substrate as claimed in claim 6, wherein a material of the adhesive layer is a titanium metal or a chromium metal.

8. The composite substrate as claimed in claim 1, wherein the metallic glass layer is formed on the amorphous metallic substrate using a magnetron sputtering method.

9. The composite substrate as claimed in claim 1, wherein the amorphous metallic substrate is formed using a casting process.
